(19) United States
(12) Patent Application Publication
(10) Pub. No.: US 2010/0018603 A1
(43) Pub. Date: Jan. 28, 2010

(54) STORAGE DEVICE FOR COMPRESSED MEDIA AND METHOD FOR FUELING VEHICLES

(76) Inventors: Robert ADLER, Gerasdorf (AT); Martin Stehrlein, Rust (AT); Andreas Opfermann, Munich (DE)

Correspondence Address: The BOC Group, Inc., 575 MOUNTAIN AVENUE, MURRAY HILL, NJ, 07974-2082, US

(21) Appl. No.: 12/493,326

(22) Filed: Jun. 29, 2009

(30) Foreign Application Priority Data
Jul. 27, 2008 (DE) 102008034499.0

(51) Int. Cl. F17C 5/06; F17C 1/00; B60P 3/22

(52) U.S. Cl. 141/4; 220/581; 220/562

(57) ABSTRACT

A storage device for storing a compressed medium, for example hydrogen. The storage device encompasses a plurality of storage containers and a container, in which the storage containers are arranged. Furthermore a method for fueling a vehicle with gaseous hydrogen by means of a variable pilgrim step method, where the gaseous hydrogen is removed from a storage device, which is divided into at least two, preferably into four or more than four sections and is fed to the vehicle, which is to be fueled.

### CROSS REFERENCE TO RELATED APPLICATION

This application claims priority from German Patent Application Serial No. DE 10 2008 034 499.0 filed Jul. 24, 2008.

### BACKGROUND OF THE INVENTION

The invention relates to a storage device for storing a compressed medium, such as hydrogen, for example.

The invention furthermore relates to a method for fueling a vehicle with gaseous hydrogen by means of a variable pilgrim step method.

Hereinbelow, the term “vehicle” is to refer to all types of land crafts, aircrafts and watercrafts, where a fuelling with a compressed medium in particular with hydrogen, can be realized. Hereinbelow, the term “medium” is to refer to gases and gas mixtures, among others.

The supply of consumers or customers, respectively, with compressed media, such as, for example, the supply of hydrogen filling stations with compressed, gaseous hydrogen, the supply of customers with different types with compressed, gaseous nitrogen, etc., is presently realized in that the compressed media are delivered in compressed gas cylinders, in fluid tanks or by means of so-called high-pressure trailers. In particular the supply of hydrogen filling stations with compressed, gaseous hydrogen is comparatively cost-intensive. The cause for this based on the fact that the hydrogen is liquefied prior to the transport, is transported in the liquefied state from the liquefier to the hydrogen filling station and is evaporated at the hydrogen filling station and is compressed subsequently. Even though a hydrogen generation would be desirable directly on location, there are no methods available as yet, which can be realized in practice with reasonable effort.

The transport of the liquefied hydrogen typically takes place in extensively insulated storage containers, in which, however, exhaust steam losses due to the unavoidable incidence of heat from the environment may have to be dealt with.

In the alternative thereto, a transport of compressed, gaseous hydrogen can be carried out by means of high-pressure trailers. The hydrogen is thereby transported in a plurality of cylindrical storage containers, which are preferably permanently mounted on a trailer. The storage of the hydrogen in these storage containers is carried out at a pressure of between 200 and 300 bar. In response to the afore-mentioned pressures, the storage volume of such high-pressure trailers is between 3000 and 5000 Nm³. With this type of hydrogen transport, however, it is disadvantageous that only a hydrogen quantity of between 300 and 500 kg can be transported by means of a truck or trailer, respectively, which has a total weight of 40 tons.

### BRIEF SUMMARY OF THE INVENTION

It is the object of the instant invention to specify a generic storage device for storing a compressed medium, such as hydrogen, for example, which avoids the aforementioned problems. The instant invention is furthermore based on the object of specifying a generic method for fueling a vehicle with gaseous hydrogen by means of a variable pilgrim step method.

To solve this object, a generic storage device is proposed, which is characterized in that it encompasses a plurality of storage containers and a container, in which the storage containers are arranged.

With reference to the method, the posed object is solved in that the gaseous hydrogen is removed from a storage device, which is designed according to the invention and which is divided at least into two, preferably into four or more than four sections, and which is then fed to the vehicle, which is to be fueled.

Further advantageous embodiments of the storage device according to the invention for storing a compressed medium as well as the method according to the invention for fueling a vehicle with gaseous hydrogen by means of a variable pilgrim step method, which represent objects of the dependent patent claims, are characterized in that
at least nine storage containers are arranged within a container, wherein the at least nine storage containers are preferably divided into four sections—the term “divided into four sections” is to be understood hereby in such a manner that the at least nine storage containers are connected to one another by means of lines in such a manner that a storage at four different pressure levels can be carried out within a container,
the container and/or the storage containers encompass a fire protection insulation,
the storage containers consist at least partially of a carbon fiber material,
the storage containers are embodied for accommodating a medium, which is compressed to pressures of up to 1000 bar,
the container encompasses at least one gas sensor and/or means for venting the interior of the container,
the container is embodied for the transport on a transport vehicle, in particular a truck or a railway car,
the container encompasses set-up means up, wherein these means are preferably embodied so as to be height-adjustable, wherein the set-up aid is preferably designed in such a manner that it can be pulled outwards on both longitudinal sides of the container to the extent that the transport vehicle can exit from underneath the container after a lowering by means of its pneumatic suspension,
the container encompasses means for establishing a conductive connection to the potential equalization of its set-up location, for example a hydrogen filling station,
the hydrogen supplied to the vehicle, which is to be fueled, is realized prior to being fed into the vehicle, which is to be fueled,
the shaft power and cooling capacity obtained in response to the release of the hydrogen is used during the fueling process and
an intermediate storage of the hydrogen, which is fed to the vehicle, which is to be fueled, is carried out.

The storage device according to the invention now consists of a container, in which a plurality of storage containers is arranged. These preferably encompass a cylindrical shape. The current carbon fiber technology now makes it possible to realize such storage containers with a very low weight. Due to the weight of the storage container or of the storage containers, respectively, which is low as compared to the known state of the art, the weight of the stored hydrogen increases to 2100 kg in response to a total vehicle weight of 40 tons.

In the event that it is intended to use the gaseous hydrogen for a fueling at a pressure of 700 bar and at a temperature of 15° C., it is advantageous to store the hydrogen in the storage device according to the invention at a pressure of approx. 900 bar. If one or a plurality of the storage devices according to the invention are arranged on a truck or trailer, respectively, approx. 2,100 kg of hydrogen can be stored and transported at this pressure and at a total weight of the truck or trailer, respectively, of 40 tons.

### BRIEF DESCRIPTION OF THE DRAWINGS

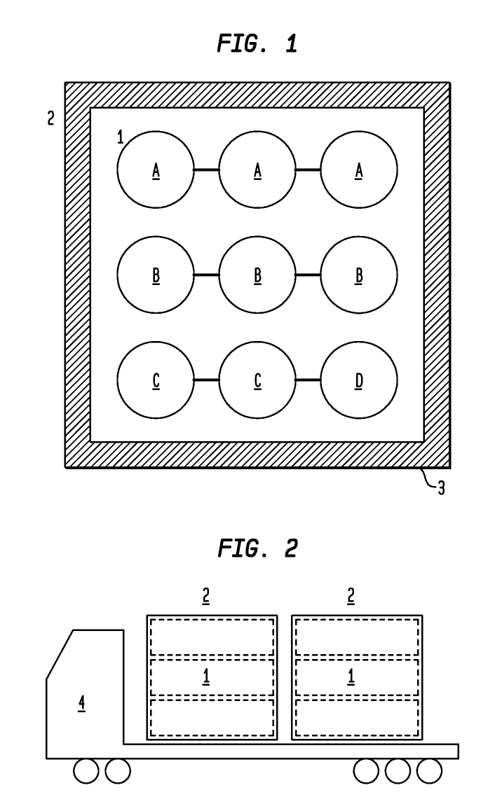

The storage device according to the invention for storing a compressed medium, in particular of hydrogen, as well as further advantageous embodiments thereof will be defined in more detail below by means of the exemplary embodiments illustrated in FIGS. 1 and 2.

### DETAILED DESCRIPTION OF THE INVENTION

FIG. 1 shows a sectional view, which is not to scale, through a possible embodiment of the storage device according to the invention. It consists of a container 2, which preferably encompasses a fire protection insulation 3. In the embodiment illustrated in FIG. 1, nine storage containers 1 are arranged within the container 2. The provision of a fire protection insulation makes it possible to reduce the safety clearance around a container, which is set down, to a minimum, for example for a hydrogen filling station.

According to an advantageous embodiment of the storage device according to the invention, the nine storage containers 1 are now divided into four sections. The term “divided into four sections” is to be understood hereby in such a manner that the nine storage containers are connected to one another by means of lines in such a manner that a storage at four different pressure levels can be carried out within a container. In the alternative to this, provision can also be made for less or more storage containers and/or less or more pressure levels can be realized. The individual sections or the belonging, respectively, of a single storage container to a section shall be characterized by the letters A, B, C and D.

In addition to the fire protection insulation 3, which is to be typically provided, provision is to be made, if applicable, for gas sensors and/or for a venting possibility or for ventilation for venting the interior of the container. They provide for the set-up and operation of such a storage device, without having to observe a protective zone around the storage device or the container 2, respectively.

Preferably, a container 2 has a length of 5 m, a width of 2.5 m and a height of 2.5 m. In the event that provision is made for nine storage containers 1, which fill the interior of the container 2 to a virtually complete extent, it is possible for such a container to accommodate approx. 700 kg of hydrogen in response to a storage pressure of 900 bar.

As is illustrated by means of FIG. 2, preferably two or more storage device or containers 2, respectively, are arranged on a transport vehicle 4. The storage containers 1 arranged in the container 2 are illustrated by means of a dashed line.

So as to further develop the storage device according to the invention, it is proposed for the individual storage devices or containers 2, respectively, to be embodied as so-called removable containers. This requires for the storage devices or containers 2, respectively, to encompass set-up means, wherein said means are preferably embodied so as to be height-adjustable. By means of this embodiment it is possible for the containers 2 to be loaded and unloaded by the truck 4 itself, without requiring a crane for doing so. The set-up aid is thus preferably embodied in such a manner that it can be pulled outwards on both longitudinal sides of the container 2 to the extent that the transport vehicle can exit from underneath the container 2 after a lowering by means of its pneumatic suspension (removable container principle).

Advantageously, all of the filling and/or removing devices are present on both sides in the storage device or the container 2, respectively, according to the invention.

In particular the afore-described division of the storage containers 1, which are arranged within the container 2, into a plurality of sections provides for an emptying of the storage containers 1 and for a filling of a vehicle, which is to be fueled, by means of a variable pilgrim step method. As compared to common fueling methods, such methods encompass very small power consumption.

It is emphasized that the afore-described storage device according to the invention is not only suitable for the transport as well as for the (intermediate) storage of compressed hydrogen, but similarly for every other (compressible) medium.

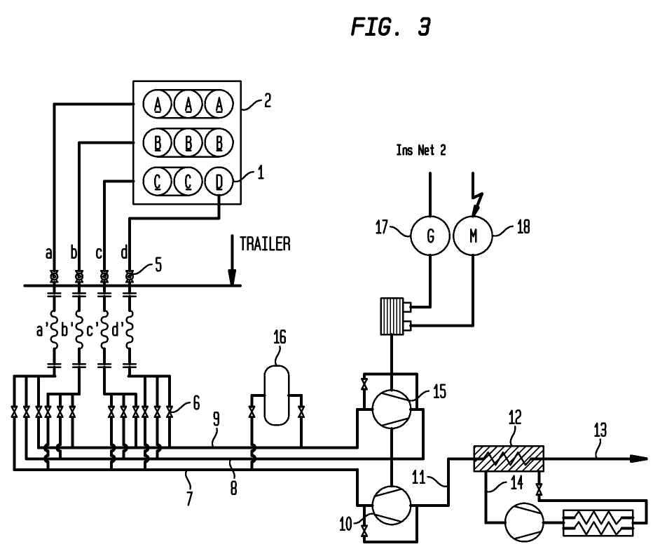

The method according to the invention for fueling a vehicle with compressed, gaseous hydrogen will be defined in more detail below by means of the exemplary embodiment illustrated in FIG. 3.

FIG. 3 illustrated a storage device according to the invention, which was already defined by means of FIG. 1, which comprises a container 2 as well as nine storage containers 1, which arranged therein. As was also already defined by means of FIG. 1, the storage containers 1 are divided into four sections A to D.

Each of the afore-mentioned four sections A to D can be connected to the network of the hydrogen filling station via a separate line a to d. Preferably, this takes place by means of suitable quick-action couplings 5.

At the fuel station, the four afore-mentioned lines a to d of the storage device according to the invention continue in lines a′ to d′. Each of these four lines a′ to d′ now splits up into the three lines, which, when merged, form three main lines 7, 8 and 9. For obvious reasons, provision is to be made in the afore-mentioned lines or line branchings, respectively, for (locking) valves 6.

As already mentioned, the gaseous hydrogen in the storage containers 1 can be stored at a pressure of up to 900 bar. Typically, the fueling of a vehicle with hydrogen is carried out at a pressure of 700 bar and at a temperature of 15° C. Due to the heating of the hydrogen in the storage tank of the vehicle to be fueled, which takes place during the fueling process, up to a temperature of maximally 85° C., a permanent pressure of 875 bar must be maintained in at least one of the storage containers 1 or in at least one of the four sections A to D.

In the event that a vehicle is to now be fueled with hydrogen, the storage tank thereof often encompasses a very low inner pressure of only 50 bar. The vehicle to be fueled is now connected to the three storage containers 1 of section A via the lines or line sections a, a′, 7, 11 and 13, respectively. As soon as a pressure compensation has been attained between section A and the vehicle tank, a switchover is made to the next section B, C or D.

Due to the fact that a large pressure difference prevails between section A and the vehicle tank at the onset of the fueling process, it is possible to gain comparatively much, at times even too much cooling power, at the expansion machine 10. To further develop the method according to the invention, it is thus proposed to provide a cold storage in the form of a cooling circuit 14, which serves the purpose of storing the cooling power gained at the expansion machine 10. By means of this cooling circuit 14, the temperature of the hydrogen, which is fed to the vehicle tank during the fueling process, can be averaged. The cold storage 14 thus ensures that a hydrogen temperature of approx. −40° C. can be maintained at the outlet of the heat exchanger 12 during the entire fueling process.

In response to an average fueling process, a shaft power as well as a cooling capacity of approx. 24 kJ/s can be obtained in each case by means of the expansion machine 10. The shaft power can be fed back into the power system in generator mode—provision is made for a generator 17 for this purpose. The obtained power, however, is used in an advantageous manner for driving the compressor 15.

The (central) compressor 15 serves the purpose of compressing hydrogen, which is removed from section A, for example, and which is fed to the compressor 15 via line sections a, a′ and 9 and guide it via the line sections 8, x′ (wherein x′=b′, c′ and/or d′) and x (wherein x=b,c and/or d) into at least one of the three other sections B, C and/or D. In an advantageous manner, hydrogen is always removed during the fueling process from the section having the lowest pressure and is compressed in the sections having the next higher pressure by means of the compressor 15. The provision of only one compressor 15 considerably increases the power efficiency of the fueling method according to the invention. Compared to a fueling method, where the hydrogen, which is to be compressed, is provided in liquid form, the fueling method according to the invention only has a tenth of the power demand.

Preferably, expansion machine 10 and compressor 15 are arranged on a common shaft so as to be capable of transferring the shaft power obtained in the expansion machine 10 directly to the compressor 15. Preferably, the expansion machine 10 as well as the compressor 15 are provided with a freewheel valve, so that each line can be short-circuited briefly.

The electrical peak power is generated during the expansion operation. Due to the fact that it can possibly only be fed back into the electric circuit in a comparatively extensive manner, it may be advantageous to use the obtained power to supply further system parts of the hydrogen fueling station and/or to recharge the accumulators of fuel cells or electric vehicles, which are to be fueled.

Provision is made in an advantageous manner for an additional high-pressure storage 16, which serves as a buffer in response to the changing of a storage device unit or of a container 2, respectively, and ensures at the same time that a vehicle, which is to be fueled, can also be fueled completely when the storage containers 1 of a storage device according to the invention are emptied.

By means of the afore-described variable pilgrim step method or the afore-described variable pilgrim step emptying, respectively, it is now possible to realize a fueling of a vehicle from the storage device according to the invention or from the storage containers 1 thereof, respectively, with a comparatively small energy input.

1. A storage device for storing a compressed medium comprising a plurality of storage containers and a container, in which the storage containers are arranged.

2. The storage device according to claim 1, characterized in that at least nine storage containers are arranged within a container.

3. The storage device according to claim 2, characterized in that said at least nine storage containers are divided into four sections.

4. The storage device according to claim 1, characterized in that the container and/or the storage containers further comprise a fire protection insulation.

5. The storage device according to claim 1, characterized in that the storage containers at least partially consist of a carbon fiber material.

6. The storage device according to claim 1, characterized in that the storage containers are embodied for accommodating a medium, which is compressed to pressures of up to 1000 bar.

7. The storage device according to claim 6, characterized in that said medium is hydrogen.

8. The storage device according to claim 1, characterized in that the container encompasses at least one gas sensor and/or means for venting the interior of the container.

9. The storage device according to claim 1, characterized in that the container is embodied for the transport on a transport vehicle.

10. The storage device according to claim 9, characterized in that said transport vehicle is selected from the group consisting of a truck and a railway car.

11. The storage device according to claim 1, characterized in that the container further comprises set-up means.

12. The storage device according to claim 11, characterized in that said set-up means are height-adjustable.

13. The storage device according to claim 1, characterized in that the container further comprises means for establishing a conductive connection to the potential equalization of a set-up location.

14. The storage device according to claim 1, characterized in that said set-up location is a hydrogen filling station.

15. A transport vehicle characterized in that the transport vehicle is designed to accommodate at least one storage device comprising a plurality of storage containers and a container, in which the storage containers are arranged.

16. The transport vehicle according to claim 15, characterized in that at least nine storage containers are arranged within a container.

17. The transport vehicle according to claim 16, characterized in that said at least nine storage containers are divided into four sections.

18. The transport vehicle according to claim 15, characterized in that the container and/or the storage containers further comprise a fire protection insulation.

19. The transport vehicle according to claim 15, characterized in that the storage containers at least partially consist of a carbon fiber material.

20. The transport vehicle according to claim 15, characterized in that the storage containers are embodied for accommodating a medium, which is compressed to pressures of up to 1000 bar.

21. The transport vehicle according to claim 20, characterized in that said medium is hydrogen.

22. The transport vehicle according to claim 15, characterized in that the container further comprises at least one gas sensor and/or means for venting the interior of the container.

23. The transport vehicle according to claim 15, characterized in that said transport vehicle is selected from the group consisting of a truck and a railway car.

24. The transport vehicle according to claim 15, characterized in that the container further comprises set-up means.

25. The transport vehicle according to claim 24, characterized in that said set-up means are height-adjustable.

26. The transport vehicle according to claim 15, characterized in that the container further comprises means for establishing a conductive connection to the potential equalization of a set-up location.

27. The transport vehicle according to claim 15, characterized in that said set-up location is a hydrogen filling station.

28. A method for fueling a vehicle with gaseous hydrogen by means of a variable pilgrim step method, characterized in that the gaseous hydrogen is removed from a storage device, wherein said storage device being divided at least into two sections, and then being fed to the vehicle, which is to be fueled.

29. The method according to claim 28, characterized in that at least nine storage containers are arranged within a container.

30. The method according to claim 29, characterized in that said at least nine storage containers are divided into four sections.

31. The method according to claim 28, characterized in that the container and/or the storage containers further comprises a fire protection insulation.

32. The method according to claim 28, characterized in that the storage containers at least partially consist of a carbon fiber material.

33. The method according to claim 28, characterized in that the storage containers are embodied for accommodating a medium, which is compressed to pressures of up to 1000 bar.

34. The method according to claim 28, characterized in that the container further comprises at least one gas sensor and/or means for venting the interior of the container.

35. The method according to claim 28, characterized in that the container further comprises set-up means.

36. The method according to claim 28, characterized in that said set-up means are height-adjustable.

37. The method according to claim 28, characterized in that the container further comprises means for establishing a conductive connection to the potential equalization of a set-up location.

38. The method according to claim 28, characterized in that the hydrogen fed to the vehicle, which is to be fueled, is released prior to being fed to the vehicle, which is to be fueled.

39. The method according to claim 28, characterized in that the shaft power and cooling capacity obtained in response to the release of the hydrogen is used during the fueling process.

40. The method according to claim 28, characterized in that an intermediate storage of the hydrogen, which is fed to the vehicle, which is to be fueled, is carried out.
